(19) United States
(12) Patent Application Publication
(10) Pub. No.: US 2015/0093625 A1
(43) Pub. Date: Apr. 2, 2015

(54) SEPARATOR FOR NON-AQUEOUS ELECTROLYTE SECONDARY BATTERY AND NON-AQUEOUS ELECTROLYTE SECONDARY BATTERY

(71) Applicant: Panasonic Corporation, Osaka (JP)

(72) Inventors: NOBUHIRO HIRANO, Osaka (JP); ISAO FUJIWARA, Osaka (JP); MASARU WATANABE, Hyogo (JP)

(21) Appl. No.: 14/489,520

(22) Filed: Sep. 18, 2014

(30) Foreign Application Priority Data
Sep. 27, 2013 (JP) 2013-200993

(51) Int. Cl. H01M 2/16

(52) U.S. Cl. CPC H01M 2/1633; H01M 2/1686
USPC 429/144

(57) ABSTRACT

A separator for a non-aqueous electrolyte secondary battery includes a first layer containing thermoplastic fibers, and a second layer formed on at least one side of the first layer and containing cellulose fibers as a main component. The first layer includes a mixed portion in which the thermoplastic fibers and the cellulose fibers are mixed, the mixed portion being disposed at an interface with the second layer. A total weight per area of the cellulose fibers contained in the second layer and the mixed portion is more than 5 g/m² and 20 g/m² or less.

### BACKGROUND

1. Field of the Invention

The present disclosure relates to a separator for a non-aqueous electrolyte secondary battery and a non-aqueous electrolyte secondary battery.

2. Description of the Related Art

Known examples of a separator for a non-aqueous electrolyte secondary battery include a porous film constituted by thermoplastic fibers composed of a polyester, polyethylene, or the like and a porous film constituted by cellulose fibers. A porous film including a thermoplastic fiber layer and a cellulose fiber layer is also known (refer to, for example, Japanese Unexamined Patent Application Publication No. 2013-099940 (Patent Literature 1)).

### SUMMARY

Although the separator for a non-aqueous electrolyte secondary battery disclosed in Patent Literature 1 has good permeability (air resistance), the separator does not sufficiently prevent an internal short circuit from occurring due to precipitation of lithium.

A separator for a non-aqueous electrolyte secondary battery according to the present disclosure includes a first layer containing thermoplastic fibers and a second layer that is formed on at least one side of the first layer and that contains cellulose fibers as a main component. The first layer includes a mixed portion in which the thermoplastic fibers and the cellulose fibers are mixed, the mixed portion being disposed at an interface with the second layer. A total weight per area of the cellulose fibers contained in the second layer and the mixed portion is more than 5 g/m² and 20 g/m² or less.

According to the separator according to the present disclosure, the occurrence of an internal short circuit due to precipitation of lithium can be sufficiently prevented while the separator has good permeability (air resistance).

### BRIEF DESCRIPTION OF THE DRAWINGS

FIG. 1 is a cross-sectional view illustrating a non-aqueous electrolyte secondary battery according to an embodiment of the present disclosure.

FIG. 2 is a cross-sectional view illustrating a separator for a non-aqueous electrolyte secondary battery according to an embodiment of the present disclosure.

FIG. 3 is an enlarged view of part III in FIG. 2.

FIG. 4 includes cross-sectional views illustrating a separator for a non-aqueous electrolyte secondary battery in the related art.

### DETAILED DESCRIPTION

### Finding that LED to the Present Disclosure

A point of view of an embodiment according to the present disclosure will be described. In a separator including a thermoplastic fiber layer and a cellulose fiber layer, the thickness of the cellulose fiber layer, the pore size, or the interface strength between the layers is very important in order to prevent an internal short circuit from occurring due to precipitation of lithium (lithium dendrites) caused by charging/discharging. Patent Literature 1 describes that the weight per area of the cellulose fiber layer needs to be at least 5 g/m² or less. However, the inventors of the present disclosure found that when the weight per area of the cellulose fiber layer is decreased, the thickness of the layer decreases and it becomes difficult to control a fine pore size. For example, as illustrated in FIG. 4, separation easily occurs at an interface between a cellulose fiber and a thermoplastic fiber. As a result, a large pore may be formed. Therefore, the separator described in Patent Literature 1 may not sufficiently prevent an internal short circuit from occurring due to precipitation of lithium. On the basis of the finding described above, the inventors of the present disclosure conceived the invention of embodiments described below.

A separator for a non-aqueous electrolyte secondary battery according to a first embodiment of the present disclosure includes, for example, a first layer containing thermoplastic fibers, and a second layer formed on at least one side of the first layer and containing cellulose fibers as a main component. The first layer includes a mixed portion in which the thermoplastic fibers and the cellulose fibers are mixed, the mixed portion being disposed at an interface with the second layer. A total weight per area of the cellulose fibers contained in the second layer and the mixed portion is more than 5 g/m² and 20 g/m² or less. According to the first embodiment, a total weight per area of the cellulose fibers contained in the second layer and the mixed portion is more than 5 g/m² and 20 g/m² or less. In this case, the thickness of the second layer containing the cellulose fibers is increased, and the degree of adhesion between the thermoplastic fibers contained in the first layer and the cellulose fibers contained in the second layer and the mixed portion is increased. Thus, the interface strength between the first layer and the second layer can be increased. When the total weight per area of the cellulose fibers is more than 5 g/m² and 20 g/m² or less, good permeability can be reliably obtained. As a result, an internal short circuit due to precipitation of lithium can be sufficiently prevented while the separator has good permeability.

In a second embodiment, for example, the total weight per area of the cellulose fibers according to the first embodiment may be 8 to 17 g/m². According to the second embodiment, sufficient thicknesses of the second layer and the mixed portion can be reliably obtained and a high performance for preventing an internal short circuit from occurring can be realized while good permeability is maintained.

In a third embodiment, for example, the second layer according to the first or second embodiment may have a thickness of 5 μm or more. According to the third embodiment, a mechanical strength of the film is improved or a through-hole perpendicular to the film is not easily formed as compared with the case where the thickness of the second layer is less than 5 μm. Accordingly, the occurrence of an internal short circuit due to lithium dendrites is further suppressed.

In a fourth embodiment, for example, the cellulose fibers according to any one of the first to third embodiments may have an average fiber diameter of 0.05 μm or less. According to the fourth embodiment, a dense pore size distribution can be formed.

In a fifth embodiment, for example, the mixed portion according to any one of the first to fourth embodiments may have a thickness of at least 1 μm or more from a surface of the first layer.

In a sixth embodiment, for example, the thermoplastic fibers according to any one of the first to fifth embodiments may have an average fiber diameter of 5 to 25 μm, an average fiber length of 5 mm or more, and a weight per area of 3 to 15 g/m². According to the sixth embodiment, a separator having both a higher film strength and good permeability can be obtained.

In a seventh embodiment, for example, the separator for a non-aqueous electrolyte secondary battery according to any one of the first to sixth embodiments may have a maximum pore size of 0.2 μm or less measuring with a Perm-Porometer. According to the seventh embodiment, a mechanical strength of the film, a density of the film, a tortuosity factor of the film, etc. are improved and the occurrence of an internal short circuit due to lithium dendrites can be suppressed as compared with the case where the maximum pore size is more than 0.2 μm.

A non-aqueous electrolyte secondary battery according to an eighth embodiment of the present disclosure includes, for example, a positive electrode, a negative electrode, the separator according to any one of the first to seventh embodiments, the separator being interposed between the positive electrode and the negative electrode, and a non-aqueous electrolyte. According to the eighth embodiment, the occurrence of an internal short circuit due to precipitation of lithium can be sufficiently prevented while the separator has good permeability.

Embodiments according to the present disclosure will now be described in detail with reference to the drawings. The embodiments described below are merely illustrative, and the present disclosure is not limited thereto. It should be noted that the drawings referred to in the embodiments are schematically illustrated.

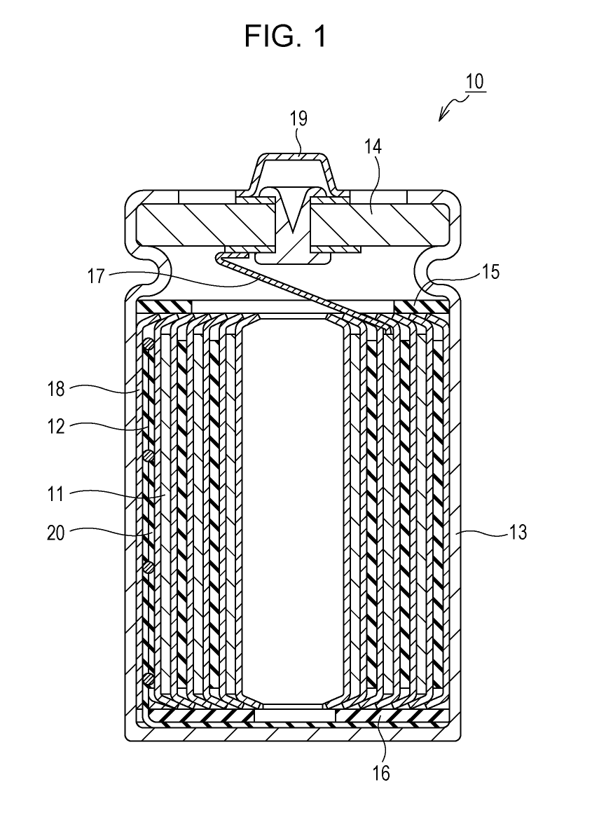

FIG. 1 is a cross-sectional view illustrating a non-aqueous electrolyte secondary battery 10, which is an example of an embodiment of the present disclosure. As illustrated in FIG. 1, the non-aqueous electrolyte secondary battery 10 includes a positive electrode 11, a negative electrode 12, a separator 20 for a non-aqueous electrolyte secondary battery (hereinafter, simply referred to as “separator 20”), the separator being interposed between the positive electrode 11 and the negative electrode 12, and a non-aqueous electrolyte (not shown). The positive electrode 11 and the negative electrode 12 are wound with the separator 20 interposed therebetween and form a wound electrode assembly together with the separator 20. The non-aqueous electrolyte secondary battery 10 includes a cylindrical battery case 13 and a sealing plate 14. The wound electrode assembly and the non-aqueous electrolyte are housed in the battery case 13. An upper insulator 15 and a lower insulator 16 are provided on both end portions in the longitudinal direction of the wound electrode assembly. An end of a positive electrode lead 17 is connected to the positive electrode 11. Another end of the positive electrode lead 17 is connected to a positive electrode terminal 19 provided on the sealing plate 14. An end of a negative electrode lead 18 is connected to the negative electrode 12. Another end of the negative electrode lead 18 is connected to an inner bottom of the battery case 13. An open end of the battery case 13 is caulked with the sealing plate 14, thus sealing the battery case 13.

FIG. 1 illustrates an example of a round columnar battery including a wound electrode assembly. However, applications of the present disclosure are not limited thereto. The battery may be, for example, a rectangular battery, a flat battery, a coin battery, or a laminate film pack battery.

The positive electrode 11 includes a positive electrode active material, for example, a lithium-containing composite oxide. Examples of the lithium-containing composite oxide include, but are not particularly limited to, lithium cobalt oxide, modified products of lithium cobalt oxide, lithium nickel oxide, modified products of lithium nickel oxide, lithium manganese oxide, and modified products of lithium manganese oxide. The modified products of lithium cobalt oxide contain, for example, nickel, aluminum, or magnesium. The modified products of lithium nickel oxide contain, for example, cobalt or manganese.

The positive electrode 11 includes a positive electrode active material as an essential component, and a binder and an electroconductive material as optional components. Examples of the binder include polyvinylidene fluoride (PVDF), modified products of PVDF, polytetrafluoroethylene (PTFE), and modified polyacrylonitrile rubber particles. PTFE and the rubber particles are preferably used in combination with, for example, carboxymethyl cellulose (CMC), polyethylene oxide (PEO), and soluble modified polyacrylonitrile rubber, all of which have an effect of increasing the viscosity. Examples of the electroconductive material include acetylene black, ketjenblack, and various types of graphite.

The negative electrode 12 includes a negative electrode active material, for example, a carbon material such as graphite, a silicon-containing material, or a tin-containing material. Examples of the graphite include natural graphite and artificial graphite. Alternatively, metallic lithium or a lithium alloy containing tin, aluminum, zinc, magnesium, or the like may be used.

The negative electrode 12 includes a negative electrode active material as an essential component, and a binder and an electroconductive material as optional components. Examples of the binder include PVDF, modified products of PVDF, styrene-butadiene copolymers (SBR), and modified products of SBR. Among these binders, SBR and modified products thereof are particularly preferable from the viewpoint of chemical stability. SBR and modified products thereof are preferably used in combination with CMC, which has an effect of increasing the viscosity.

The separator 20 is interposed between the positive electrode 11 and the negative electrode 12, and has a function of permeating Li ions while preventing a short circuit from occurring between the positive electrode 11 and the negative electrode 12. The separator 20 is a porous film having a large number of pores functioning as a path through which Li ions pass during charging/discharging of the non-aqueous electrolyte secondary battery 10. The separator 20 is a porous film containing thermoplastic fibers 24 and cellulose fibers 25 as a main component, as described in more detail below. For example, a porous layer containing, as a main component, heat-resistant fine particles such as particles composed of iron oxide, SiO₂ (silica), Al₂O₃ (alumina), or TiO₂ may be formed on the porous film or in the porous film.

The non-aqueous electrolyte is not particularly limited. A non-aqueous solvent in which a lithium salt is dissolved is preferably used as the non-aqueous electrolyte. Examples of the lithium salt include LiPF₆ and LiBF₄. Examples of the non-aqueous solvent include ethylene carbonate (EC), propylene carbonate (PC), dimethyl carbonate (DMC), diethyl carbonate (DEC), and ethyl methyl carbonate (EMC). These are preferably used in combination of two or more compounds.

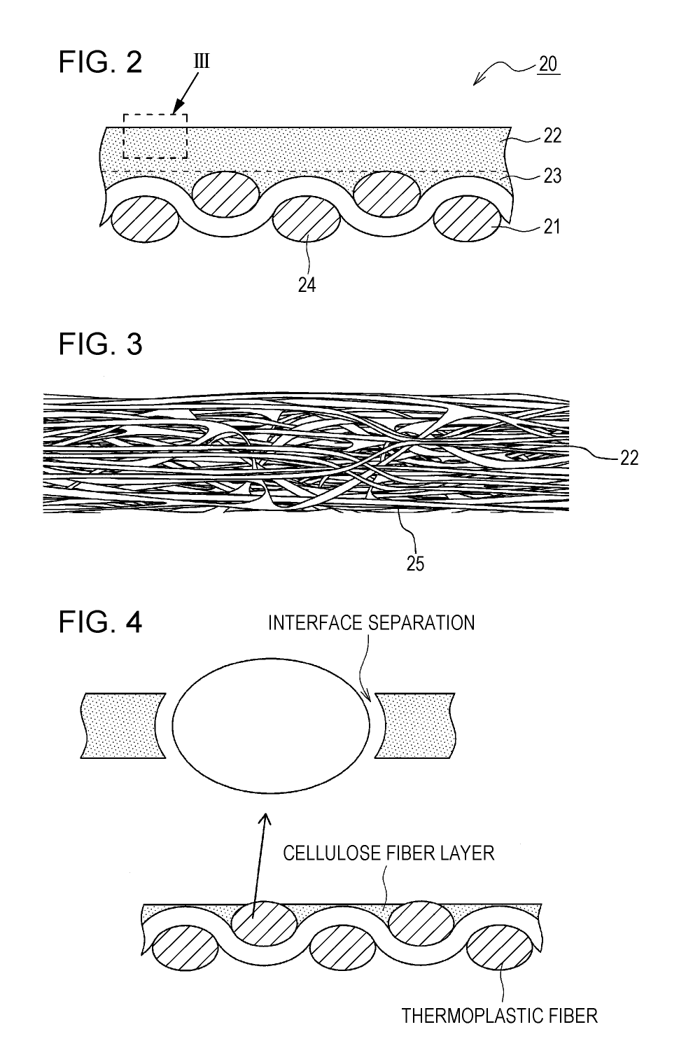

FIGS. 2 and 3 are cross-sectional views illustrating a separator 20 according to an embodiment of the present disclosure. As illustrated in FIGS. 2 and 3, the separator 20 includes a first layer 21 containing thermoplastic fibers 24 and a second layer 22 formed on one side of the first layer 21 and containing cellulose fibers 25 as a main component. The first layer 21 has a mixed portion 23 in which the thermoplastic fibers 24 and the cellulose fibers 25 are mixed, the mixed portion 23 being disposed at an interface with the second layer 22. A total weight per area of the cellulose fibers 25 contained in the second layer 22 and the mixed portion 23 is more than 5 g/m² and 20 g/m² or less.

### [First Layer 21 (Thermoplastic Fiber Layer)]

The first layer 21 is a thermoplastic fiber layer (porous film) and has a function of increasing the film strength of the separator 20. A non-woven fabric including the thermoplastic fibers 24 can be used as the first layer 21. The non-woven fabric can be produced by a known manufacturing method, for example, by papermaking the thermoplastic fibers 24 using a wet papermaking method or a dry papermaking method. A non-woven fabric preferably produced by a dry papermaking method such as a spun-bond method, a thermal bond method, or a melt flow method is suitably used as the first layer 21. Such a non-woven fabric produced by a dry papermaking method functions as a first layer 21 having suitable physical properties.

As described above, the first layer 21 has a mixed portion 23 in which the thermoplastic fibers 24 and the cellulose fibers 25 are mixed, the mixed portion 23 being disposed at an interface with the second layer 22. The mixed portion 23 will be described in detail below.

Examples of the thermoplastic constituting the thermoplastic fibers 24 include styrene resins, (meth)acrylic resins, organic acid vinyl ester-based resins, vinyl ether-based resins, halogen-containing resins, polyolefins, polycarbonates, polyesters, polyamides, thermoplastic polyurethanes, polysulfone-based resins, polyphenylene ether-based resins, polyphenylene sulfide-based resins, silicone resins, rubber, and elastomers. These thermoplastics may be used alone or in combination of two or more resins. Among these, from the viewpoint of solvent resistance, heat resistance, etc., polyolefin fibers, polyester fibers, and polyvinyl alcohol fibers are preferable.

Examples of the polyolefins include homopolymers and copolymers of olefins having 2 to 6 carbon atoms, such as polyethylene-based resins, e.g., polyethylene and ethylene-propylene copolymers; polypropylene-based resins, e.g., polypropylene, propylene-ethylene copolymers, and propylene-butene copolymers; poly(methylpentene-1), and propylene-methylpentene copolymers. Examples of the polyolefins further include ethylene-vinyl acetate copolymers, ethylene-vinyl alcohol copolymers, ethylene-(meth)acrylic acid copolymers, and ethylene-(meth)acrylic acid ester copolymers.

Examples of the polyesters include polyalkylene arylates such as polyethylene terephthalate, polypropylene terephthalate, polybutylene terephthalate, and polyethylene phthalate. Examples of an acid component forming the polyesters include aromatic dicarboxylic acids such as terephthalic acid, isophthalic acid, 2,7-naphthalenedicarboxylic acid, and 2,5-naphthalenedicarboxylic acid; and alkane dicarboxylic acids such as adipic acid, azelaic acid, and sebacic acid. Examples of a diol component forming the polyesters include alkane diols such as ethylene glycol, propylene glycol, butanediol, and neopentyl glycol; alkylene glycols such as diethylene glycol and polyethylene glycol; and aromatic diols such as bisphenol A.

An average fiber diameter of the thermoplastic fibers 24 is preferably 5 to 25 μm, and more preferably 10 to 20 μm from the viewpoint of permeability (liquid permeability or air permeability), the film strength, etc. An average fiber length of the thermoplastic fibers 24 is preferably 5 mm or more and more preferably 10 mm or more from the viewpoint of film strength, etc. The upper limit of the average fiber length is not particularly limited. The average fiber diameter and the average fiber length of the thermoplastic fibers 24 can be measured by using an electron micrograph (SEM). (An average fiber diameter and an average fiber length of the cellulose fibers 25 can also be measured in the same manner.)

The weight per area of the first layer 21 is preferably 3 to 15 g/m² and more preferably 5 to 10 g/m² from the viewpoint of permeability (liquid permeability or air permeability), film strength, etc. An average pore size of the first layer 21 is preferably 0.2 to 10 μm, and more preferably 0.3 to 5 μm. The average pore size can be controlled in an appropriate range by adjusting the weight per area, and the fiber diameter and the fiber length of the thermoplastic fibers 24. The first layer 21 is preferably formed by using the thermoplastic fibers 24 having an average fiber diameter of 5 to 25 μm and an average fiber length of 5 mm or more and adjusting the weight per area to 3 to 15 g/m². In this case, the separator 20 having a higher film strength and good permeability can be obtained.

An average thickness of the first layer 21 (after a compression step) is preferably 3 to 30 μm, more preferably 5 to 20 μm, and particularly preferably 10 to 15 μm. A thickness of the non-woven fabric before the compression, the non-woven fabric forming the first layer 21, is, for example, 20 to 40 μm. The thickness of the first layer 21 can be measured by SEM observation. (A thickness of the second layer 22 can also be measured in the same manner.)

In addition to the thermoplastic fibers 24, the first layer 21 may further contain sizing agents, waxes, inorganic fillers, organic fillers, colored materials, stabilizers (such as an antioxidant, a heat stabilizer, and an ultraviolet absorber), plasticizing agents, antistatic agents, flame retardants, etc.

### [Second Layer 22 (Cellulose Fiber Layer)]

The second layer 22 is a cellulose fiber layer (porous film), and is formed on one side of the first layer 21. The second layer 22 may be formed on both sides of the first layer 21. However, from the viewpoint of, for example, obtaining the separator 20 in the form of a thin film, the second layer 22 is preferably formed on one side of the first layer 21. The second layer 22 contains cellulose fibers 25 as a main component. As described below, cellulose nano-fibers having an average fiber diameter of 0.05 μm (50 nm) or less are preferably used as the cellulose fibers 25. The separator 20 is produced by preparing an aqueous dispersion liquid of cellulose nano-fibers, and applying the aqueous dispersion liquid onto a non-woven fabric that forms the first layer 21.

Herein, the phrase “contains cellulose fibers 25 as a main component” means that the cellulose fibers 25 are contained in an amount of 80% by mass or more relative to the total amount of the second layer 22. That is, the second layer 22 may further contain organic fibers and the like other than the cellulose fibers 25 as long as the cellulose fibers 25 are contained in an amount of 80% by mass or more. Alternatively, the second layer 22 may be constituted by only the cellulose fibers 25. The organic fibers other than the cellulose fibers 25 may be contained in a state where the organic fibers and the cellulose fibers 25, which are a main component, are stacked to each other. Alternatively, the organic fibers may be contained in a state where the organic fibers are mixed with the cellulose fibers 25.

Examples of the cellulose fibers 25 include, but are not particularly limited to, natural cellulose fibers such as softwood pulp, hardwood pulp, esparto pulp, abaca pulp, sisal pulp, and cotton pulp; and regenerated cellulose fibers, such as lyocell, produced by spinning any of these natural cellulose fibers with an organic solvent.

The cellulose fibers 25 are preferably fibrillated cellulose fibers from the viewpoint of pore size control, the retention property of a non-aqueous electrolyte, battery life, etc. The term “fibrillation” means, for example, a phenomenon in which the fibers formed of a large number of bundled structures of fibrils are separated into fibrils by a frictional operation or the like, and surfaces of the fibers become fluffed. The fibrillation can be performed by beating fibers with a beating machine such as a beater, a refiner, or a mill, or by fibrillating fibers with a bead mill, an extrusion kneading machine, or a shearing force under high pressure.

An average fiber diameter of the cellulose fibers 25 is preferably 0.05 μm or less, and more preferably 0.002 to 0.03 μm. The second layer 22 is preferably formed by using two types of cellulose fibers 25 having different average fiber diameters. For example, cellulose fibers A having an average fiber diameter of 0.02 μm and an average fiber length of 50 μm or less and cellulose fibers B having an average fiber diameter of 0.7 μm and an average fiber length of 50 μm or less are preferably used in combination. By using the cellulose fibers A, for example, a dense pore size distribution of a pore size of 0.05 μm or less can be formed. By using the cellulose fibers B, for example, a pore size distribution of a pore size of 0.2 μm or less can be formed.

The maximum pore size of the second layer 22 is 0.2 μm or less. Preferably, in the pore size distribution of the second layer 22, the proportion of pores having a pore size in the range of 0.05 μm or less is 50% or more of the total pore volume. In the case where charging and discharging are repeatedly performed or overcharging is performed, lithium dendrites may generate on a surface of the negative electrode 12. Lithium dendrites gradually grow toward the positive electrode 11 along the shortest path. When the lithium dendrites penetrate through the separator and reach the positive electrode 11, the lithium dendrites may cause an internal short circuit. However, as in the separator 20, since the cellulose fibers 25 are formed of a large number of bundles, the maximum pore size of the second layer 22 is 0.2 μm or less, and the proportion of pores having a pore size of 0.05 μm or less is 50% or more of the total pore volume, the mechanical strength of the film, the density of the film, the tortuosity factor of the film, etc. are increased and the occurrence of an internal short circuit is suppressed.

Herein, the term “tortuosity factor” corresponds to the shape of the path of a pore penetrating from a surface to an opposing surface of a porous film. The phrase “tortuosity factor is small” indicates that the number of through-holes perpendicular to a film is large and a small tortuosity factor may cause an internal short circuit due to lithium dendrites. Since the second layer 22 has a higher-order structure formed of fine fibers having an average fiber diameter of 0.05 μm or less and an average fiber length of 50 μm or less and fluffed by fibrillation, the second layer 22 is a dense porous film having a high tortuosity factor. Considering that a decrease in the output of the non-aqueous electrolyte secondary battery is suppressed while the mechanical strength of the film and the like are secured, the maximum pore size of the second layer 22 is preferably 0.1 to 0.2 μm. The proportion of pores having a pore size in the range of 0.05 μm or less is preferably 50% to 80% of the total pore volume.

When the maximum pore size of the second layer 22 exceeds 0.2 μm, the mechanical strength of the film, the density of the film, the tortuosity factor of the film, etc. are decreased and an internal short circuit due to lithium dendrites easily occurs, as compared with the case where the maximum pore size is 0.2 μm or less. When the maximum pore size is less than 0.1 μm, the input and output may be decreased. When the proportion of pores having a pore size in the range of more than 0.05 μm exceeds 50% of the total pore volume (when the proportion of pores having a pore size in the range of 0.05 μm or less is less than 50% of the total pore volume), the mechanical strength of the film, the density of the film, the tortuosity factor of the film, etc. are decreased and an internal short circuit due to lithium dendrites easily occurs, as compared with the case where the proportion of pores having a pore size in the range of 0.05 μm or less is 50% or more of the total pore volume. When the proportion of pores having a pore size in the range of more than 0.05 μm is less than 20%, the input and output are decreased.

The pore size distribution of the second layer 22 is measured by using, for example, a Perm-Porometer with which a pore size measurement by a bubble point method (JIS K3832, ASTM F316-86) can be performed. The pore size distribution can be measured by using, for example, a Perm-Porometer (Model: CFP-1500AE, manufactured by Seika Corporation). Pores having a size of 0.01 μm or less can be measured by using, as a test liquid, SILWICK (20 dyne/cm) or GALWICK (16 dyne/cm), which is a solvent having a low surface tension, and increasing the measurement pressure of dry air to 3.5 MPa. The pore size distribution is determined from the amount of air passed at the measurement pressure.

Herein, the term “maximum pores size of the second layer 22” refers to the maximum pore size in a peak observed from the pore size distribution obtained as described above. The proportion (%) of pores having a pore size in the range of 0.05 μm or less to the total pore volume can be determined by calculating a proportion (B/A) of the peak area (B) observed in a pore size of 0.05 μm or less to the total peak area (A) observed from the pore size distribution.

In the pore size distribution measured by using a Perm-Porometer, the second layer 22 preferably has a wide distribution of the pore size in the range of 0.01 to 0.2 μm, and preferably has at least one peak in the range of 0.01 to 0.2 μm of the pore size.

The total weight per area of the cellulose fibers 25 contained in the second layer 22 and the mixed portion 23 is more than 5 g/m² and 20 g/m² or less from the viewpoint of, for example, preventing an internal short circuit from occurring due to lithium dendrites. The total weight per area of the cellulose fibers 25 is more preferably 8 to 17 g/m² and particularly preferably 10 to 15 g/m². When the weight per area is in this range, the thicknesses of the second layer 22 and the mixed portion 23 can be sufficiently secured while good permeability is maintained, and an excellent performance for preventing an internal short circuit from occurring can be exhibited. On a surface of the separator 20, the surface being disposed on the second layer 22 side, a dense microporous film is formed in which the cellulose fibers 25 are strongly bonded to each other through hydrogen bonds without exposure of the thermoplastic fibers 24 that form the first layer 21.

The thickness of the second layer 22 is preferably 5 to 30 μm in total from the viewpoint of, for example, improving the charge/discharge performance of the non-aqueous electrolyte secondary battery 10 in addition to the mechanical strength of the film, etc. When the thickness of the second layer 22 is 5 μm or more, the mechanical strength of the film is improved or a through-hole perpendicular to the film is not easily formed and thus the occurrence of an internal short circuit due to lithium dendrites is further suppressed as compare with the case where the thickness of the second layer 22 is less than 5 μm. When the thickness of the second layer 22 is 30 μm or less, the decrease in the charge/discharge performance is suppressed as compared with the case where the thickness exceeds 30 μm.

The porosity of the second layer 22 is not particularly limited, but is preferably 30% to 70% from the viewpoint of the charge/discharge performance, etc. Herein, the term “porosity” means the percentage of the total volume of pores in a porous film relative to the volume of the porous film. The permeability of the second layer 22 is not particularly limited, but is preferably 150 sec/100 cc to 800 sec/100 cc from the viewpoint of the charge/discharge performance, etc. The permeability is determined by passing air through a porous film at a constant pressure in a direction perpendicular to a surface of the porous film, and measuring the time necessary for 100 cc of the air to pass through the porous film.

### [Mixed Portion 23]

The mixed portion 23 is a portion in which the thermoplastic fibers 24 and the cellulose fibers 25 are mixed, and is formed at an interface with the second layer 22, more specifically, in a portion having a predetermined thickness from a surface of the first layer 21. In the mixed portion 23, the cellulose fibers 25 adhere to the peripheries of the thermoplastic fibers 24, and the cellulose fibers 25 fill the gaps between the thermoplastic fibers 24. In the separator 20, the thermoplastic fibers 24 and the cellulose fibers 25 are strongly bonded to each other and the interface strength between the first layer 21 and the second layer 22 is increased by the presence of the mixed portion 23.

The thickness of the mixed portion 23 is preferably at least 1 μm or more from a surface of the first layer 21. Note that the term “surface of the first layer 21” means a surface along an imaginary plane disposed on the first layer 21. The mixed portion 23 is formed, for example, in a step of forming the second layer 22 by applying an aqueous dispersion liquid of the cellulose fibers 25 onto a non-woven fabric that forms the first layer 21, by causing the aqueous dispersion liquid to permeate through the first layer 21. As a result of this permeation, the cellulose fibers 25 are present inside the surface of the non-woven fabric in a range of at least 1 μm or more, thus forming the mixed portion 23. The thickness of the mixed portion 23 can be controlled by adjusting the amount of coating of the aqueous dispersion liquid, that is, the total weight per area of the cellulose fibers 25 contained in the second layer 22 and the mixed portion 23. As described above, the weight per area is more than 5 g/m².

Preferably, the mixed portion 23 is completely covered with the second layer 22. That is, preferably, the thermoplastic fibers 24 in the mixed portion 23 are not exposed to a surface of the separator 20, the surface being disposed on the second layer 22 side. With this structure, a dense microporous film in which the cellulose fibers 25 are strongly bonded to each other through hydrogen bonds is formed on the surface of the separator 20. Accordingly, for example, it is possible to effectively prevent the generation of a large pore (refer to FIG. 4) due to the separation at the interface between a cellulose fiber and a thermoplastic fiber.

### [Manufacturing Method of Separator 20]

As described above, the separator 20 can be prepared by applying, onto a surface of a non-woven fabric that forms the first layer 21, an aqueous dispersion liquid in which the cellulose fibers 25 are dispersed in an aqueous solvent, and drying the aqueous dispersion liquid. Examples of the aqueous solvent include aqueous solvents which contain a surfactant, a thickener, etc. and whose viscosity and whose dispersion state are adjusted. From the viewpoint of, for example, forming pores in the porous film, an organic solvent may be added to the aqueous dispersion liquid. The organic solvent is selected from solvents having high compatibility with water. Examples thereof include polar solvents such as glycols, e.g., ethylene glycol; glycol ethers; glycol diethers; and N-methyl-pyrrolidone. By using a binder of an aqueous solution of CMC, PVA, or the like and a binder of an emulsion of SBR or the like, the viscosity of the slurry can be adjusted and the film strength of the porous film can be increased. Furthermore, a porous film may be produced by mixing long resin fibers with a slurry to the extent that a coating property of the slurry is not affected, and melt-bonding the resin fibers by hot calender pressing.

### EXAMPLES

The present disclosure will be further described by using Examples. However, the present disclosure is not limited to these Examples.

### Example 1

### Selection of Non-Woven Fabric

A non-woven fabric A1 composed of polypropylene fibers and polyethylene fibers, having a weight per area of 10 g/m² and an average fiber diameter of 12 μm, and produced by a spun-bond method was selected as a non-woven fabric constituting a first layer (thermoplastic fiber layer).

### [Preparation of Cellulose Nano-Fiber Slurry]

In 100 parts by mass of water, 70 parts by mass of cellulose fibers having a fiber diameter of 0.5 μm or less (average fiber diameter: 0.02 μm) and a fiber length of 50 μm or less and 30 parts by mass of cellulose fibers having a fiber diameter of 0.5 μm or more and 5 μm or less (average fiber diameter: 0.7 μm) and a fiber length of 50 μm or less were dispersed. Subsequently, 5 parts by mass of an ethylene glycol solution was added to the resulting dispersion liquid to prepare an aqueous dispersion liquid (cellulose nano-fiber slurry B1).

### [Preparation of Separator]

The cellulose nano-fiber slurry B1 was applied onto a surface of the non-woven fabric A1 with a weight per area of 10 g/m², and dried to prepare a stacked film including the non-woven fabric A1 and a second layer (cellulose fiber layer) formed on the surface of the non-woven fabric A1. This stacked film was compressed with a calender roll at 140° C. to prepare a separator C1 having a film thickness of 23.4 μm. Table 2 shows physical properties of the separator C1.

### Example 2

A separator C2 was prepared as in Example 1 except that a non-woven fabric A2 composed of conjugated fibers including a polypropylene core and a polyethylene shell, having a weight per area of 8 g/m² and an average fiber diameter of 15 μm, and produced by a thermal bond method was used as a non-woven fabric constituting a thermoplastic fiber layer. Table 2 shows physical properties of the separator C2.

### Example 3

A separator C3 was prepared as in Example 1 except that a non-woven fabric A3 composed of conjugated fibers including a polypropylene core and a polyethylene shell, having a weight per area of 5 g/m² and an average fiber diameter of 20 μm, and produced by a thermal bond method was used as a non-woven fabric constituting a thermoplastic fiber layer. Table 2 shows physical properties of the separator C3.

### Example 4

A separator C4 was prepared as in Example 3 except that the cellulose nano-fiber slurry B1 was applied with a weight per area of 5.2 g/m². Physical properties of the separator C4 (refer to Table 2) were measured.

### Example 5

A separator C5 was prepared as in Example 2 except that the cellulose nano-fiber slurry B1 was applied with a weight per area of 15 g/m². Physical properties of the separator C5 (refer to Table 2) were measured.

### Example 6

A separator C6 was prepared as in Example 1 except that the cellulose nano-fiber slurry B1 was applied with a weight per area of 15 g/m². Physical properties of the separator C6 (refer to Table 2) were measured.

### Example 7

A separator C7 was prepared as in Example 3 except that the cellulose nano-fiber slurry B1 was applied with a weight per area of 12 g/m². Physical properties of the separator C7 (refer to Table 2) were measured.

### Comparative Example 1

The cellulose nano-fiber slurry B1 was applied onto a glass substrate with a weight per area of 20 g/m², then dried, and compressed to prepare a porous film composed of only cellulose fibers. The porous film was separated from the glass substrate to prepare a separator X1. Table 2 shows physical properties of the separator X1.

### Comparative Example 2

A non-woven fabric A4 having a weight per area of 10 g/m², an average fiber diameter of 4 μm, and an average fiber length of 2.5 mm, and produced by a wet papermaking method, and a porous film composed of only cellulose fibers, the porous film being prepared as in Comparative Example 1 (except that the weight per area was changed to 10 g/m²) were stacked. The resulting stacked film was thermo-compressed by using a calender roll at 140° C. Thus, a separator X2 was prepared. Table 2 shows physical properties of the separator X2.

### Comparative Example 3

A separator X3 was prepared as in Example 1 except that the cellulose nano-fiber slurry B1 was applied with a weight per area of 4 g/m². Physical properties of the separator X3 (refer to Table 2) were measured.

Table 1 summarizes the materials, the weights per area, etc. of the separators in Examples 1 to 7 and Comparative Examples 1 to 3.

TABLE 1

| | Non-woven fabric (1) | | | | | Cellulose fiber layer (2) | | |
|---|---|---|---|---|---|---|---|---|
| | | Weight | Fiber | Fiber | Thick- | Weight | | Stacking |
| | | per area | diameter | length | ness | per area | Method for | ratio |
| | Type | (g/m²) | (μm) | (mm) | (μm) | (g/m²) | forming layer | (2)/(1) |
| Example 1 | A1 | 10 | 12 | >50 | 40 | 10 | Slurry coating | 1.0 |
| Example 2 | A2 | 8 | 15 | >50 | 35 | 10 | Slurry coating | 1.3 |
| Example 3 | A3 | 5 | 20 | >50 | 20 | 10 | Slurry coating | 2.0 |
| Example 4 | A3 | 5 | 20 | >50 | 20 | 5.2 | Slurry coating | 1.0 |
| Example 5 | A2 | 8 | 15 | >50 | 35 | 15 | Slurry coating | 1.9 |
| Example 6 | A1 | 10 | 12 | >50 | 40 | 15 | Slurry coating | 1.5 |
| Example 7 | A3 | 5 | 20 | >50 | 20 | 12 | Slurry coating | 2.4 |
| Comparative | — | — | — | — | — | 20 | — | |
| Example 1 | | | | | | | | |
| Comparative | A4 | 10 | 4 | 2.5 | 22 | 10 | Thermo-compres- | |
| Example 2 | | | | | | | sion bonding | |
| Comparative | A1 | 10 | 12 | >50 | 40 | 4 | Slurry coating | |
| Example 3 | | | | | | | | |

Methods for evaluating the physical properties of the separators in Examples 1 to 7 and Comparative Examples 1 to 3 are as follows.

### [Evaluation of Average Thickness]

An average thickness was evaluated by a method for measuring a thickness of a plastic film or sheet by mechanical scanning (method A), the method being specified in JIS K 7130, Plastics-Film and sheeting-Determination of thickness.

### [Evaluation of Presence or Absence of Mixed Portion]

The presence or absence of the mixed portion was evaluated as follows. When a separator was observed with a scanning electron microscope (SEM) from the thermoplastic fiber layer side, whether or not a cellulose fiber was present in front of fibers of a thermoplastic fiber layer adjacent to a cellulose fiber layer was examined. Alternatively, in a SEM observation of a cross section of the separator, whether or not a cellulose fiber crossed an interface of the thermoplastic fiber layer with the cellulose fiber layer and located on the side of the fiber ends of the thermoplastic fiber layer was examined.

### [Evaluation of Permeability]

Permeability (air resistance) was evaluated in accordance with JIS P8117 (Paper and board-Determination of air permeance and air resistance (medium range)—Part 5: Gurley method). The permeability was determined as a permeating time (sec) of 100 cc of air.

### [Evaluation of Tensile Strength]

A tensile strength was evaluated (20 mm/min) in accordance with JIS K7127 (Plastics-Determination of tensile properties-Part 3: Test conditions for films and sheets). A test piece having a width of 15 mm and a length of 150 mm was used.

### [Evaluation of Piercing Strength]

A piercing strength was evaluated (5 mm/min) in accordance with JIS K7181 (Plastics-Determination of compressive properties). A test piece having a size of 15 mm or more, and a piercing needle having a diameter φ of 1 mm were used.

### [Evaluation of Bubble Point]

A bubble point was evaluated by using a Perm-Porometer. The evaluation results of the bubble point represent the maximum pore size of a separator. Data obtained by this measuring method is not affected by the non-woven fabric and represents only a physical property (maximum pore size) of a cellulose fiber layer. (This also applies to an average pore size.)

### [Evaluation of Average Pore Size]

An average pore size was evaluated by using a Perm-Porometer.

Table 2 summarizes the physical properties of the separators in Examples 1 to 7 and Comparative Examples 1 to 3.

TABLE 2

| | Average | | | Tensile | Piercing | Bubble | Average |
|---|---|---|---|---|---|---|---|
| | thickness | Mixed | Permeability | strength | strength | point | pore size |
| | (μm) | portion | (s/100 cc) | (N/mm²) | (N/φ1) | (nm) | (nm) |
| Example 1 | 23.4 | Present | 400 | 150 | 3.9 | 200 | 20 |
| Example 2 | 18.4 | Present | 400 | 130 | 3.7 | 200 | 20 |
| Example 3 | 19.9 | Present | 400 | 115 | 3.3 | 200 | 20 |
| Example 4 | 14.9 | Present | 250 | 105 | 3.2 | 200 | 20 |
| Example 5 | 22.6 | Present | 800 | 150 | 3.8 | 200 | 20 |
| Example 6 | 27.6 | Present | 800 | 170 | 4.1 | 200 | 20 |
| Example 7 | 19.8 | Present | 600 | 120 | 3.3 | 200 | 20 |
| Comparative | 19.0 | — | 800 | 5 | 0.5 | 200 | 20 |
| Example 1 | | | | | | | |
| Comparative | 20.0 | Not | 500 | 13 | 0.8 | 200 | 20 |
| Example 2 | | present | | | | | |
| Comparative | 15.0 | Present | 200 | 120 | 2.8 | 1,200 | 80 |
| Example 3 | | | | | | | |

The separators of Examples each had a mixed portion, and thermoplastic fibers in the mixed portion were completely covered with the cellulose fiber layer. The separators of Examples each had a high piercing strength, and had good permeability and a good tensile strength. Thus, the separators of Examples have excellent piercing strengths and excellent tensile strengths while having good permeability, and thus can sufficiently prevent an internal short circuit from occurring due to precipitation of lithium. In contrast, regarding the separators of Comparative Examples, separators having high permeability had low piercing strengths and low tensile strengths, and a separator having a high piercing strength and a high tensile strength had low permeability. Although the separator X1 includes a microporous film, the strengths of the separator X1 are poor. The separator X2 is a multi-layer film prepared by thermo-compression bonding. Accordingly, in the evaluations of the strengths, only the cellulose fiber layer was broken earlier, and the effect of stacking the non-woven fabric was not observed. Regarding the separator X3, since the thickness of the cellulose fiber layer was only 3 μm, fibers of the non-woven fabric were exposed to the surface and adhesiveness due to hydrogen bonds with cellulose fibers was not secured. Consequently, a large diameter due to a pinhole was observed.

In Examples 2 and 5, although the weight per area of the non-woven fabric was decreased to 8 g/m², sufficient strengths were obtained by increasing the fiber diameter to 15 μm. Similarly, in Examples 3, 4, and 7, although the weight per area of the non-woven fabric was decreased to 5 g/m², sufficient strength were obtained by increasing the fiber diameter to 20 μm. In Example 4, although the weight per area of the non-woven fabric was decreased to 5.2 g/m², a thickness of the cellulose fiber layer of 5 μm was secured. It was found that the separator in Example 4 included a microporous film in view of the results of the air resistance, the bubble point, and the average pore size.

What is claimed is:

1. A separator for a non-aqueous electrolyte secondary battery, the separator comprising:
a first layer containing thermoplastic fibers; and
a second layer formed on at least one side of the first layer and containing cellulose fibers as a main component,
wherein the first layer includes a mixed portion in which the thermoplastic fibers and the cellulose fibers are mixed, the mixed portion being disposed at an interface with the second layer, and
a total weight per area of the cellulose fibers contained in the second layer and the mixed portion is more than 5 g/m² and 20 g/m² or less.

2. The separator according to claim 1, wherein the total weight per area of the cellulose fibers is 8 to 17 g/m².

3. The separator according to claim 1, wherein the second layer has a thickness of 5 μm or more.

4. The separator according to claim 1, wherein the cellulose fibers have an average fiber diameter of 0.05 μm or less.

5. The separator according to claim 1, wherein the mixed portion has a thickness of at least 1 μm or more from a surface of the first layer.

6. The separator according to claim 1, wherein the thermoplastic fibers have an average fiber diameter of 5 to 25 μm, an average fiber length of 5 mm or more, and a weight per area of 3 to 15 g/m².

7. The separator according to claim 1, wherein a maximum pore size measured with a Perm-Porometer is 0.2 μm or less.

8. A non-aqueous electrolyte secondary battery comprising:
a positive electrode;
a negative electrode;
the separator according to claim 1, the separator being interposed between the positive electrode and the negative electrode; and
a non-aqueous electrolyte.
